(19) United States
(12) Patent Application Publication
(10) Pub. No.: US 2006/0230963 A1
(43) Pub. Date: Oct. 19, 2006

(54) A bobbin for a washing unit in a printing press

(75) Inventor: Hansson Birger, Akarp (SE)

Correspondence Address: MERCHANT & GOULD PC, P.O. BOX 2903, MINNEAPOLIS, MN, 55402-0903, US

(73) Assignee: BALDWIN JIMEK AB, Arlov (SE)

(21) Appl. No.: 10/537,522

(22) PCT Filed: Nov. 28, 2003
(86) PCT No.: PCT/SE03/01840

§ 371 Date: Jun. 9, 2006

(30) Foreign Application Priority Data
Dec. 3, 2002 (SE) 0203576-4

(51) Int. Cl. B41F 35/00

(52) U.S. Cl. 101/425

(57) ABSTRACT

A bobbin (6) for a cleaning cloth (2) in a washing unit (1) for a cylinder in a printing press is provided with internal, longitudinal or axial projections (6′) for cooperation with corresponding longitudinal grooves (7′) in a shaft (7) therefore and with embossments over at least a part of its circumferential surface.

### FIELD OF THE INVENTION

The present invention relates to a bobbin for a cleaning cloth in a washing unit for a cylinder in a printing press.

### BACKGROUND OF THE INVENTION

A washing unit is used in a printing press for cleaning one or more cylinders therein, especially the blanket cylinder. The cleaning means is a cleaning cloth, preferably wetted by a cleaning liquid. In a cleaning operation the cleaning cloth is applied in a stationary condition against the cylinder to be cleaned, which is rotating.

The cleaning cloth is supplied stepwise from a supply roll thereof in the washing unit to a return roll for used cloth. Each roll comprises a replaceable bobbin on a washing unit shaft. A fresh bobbin with unused cleaning cloth rolled thereon is supplied from a supplier, and the used cloth can be discarded in a roll on the bobbin.

In this way it will be a very quick and simple operation to provide the washing unit with a new cleaning cloth, and the dirtied cloth may be easily handled in the roll on the bobbin without contact with the dirt. There is no need to disassemble the dirty cloth from the bobbin.

In order to guarantee the proper function of the washing unit, no relative movements between on one hand the bobbin and its shaft and on the other hand the bobbin and the cloth shall be allowed.

### THE INVENTION

This proper function is according to the invention obtained in that the bobbin is provided with internal means for rotationally looking it to its shaft and with external means for preventing sliding tangential movements between the cloth and the bobbin.

Preferably, the bobbin is provided with internal, longitudinal or axial projections for cooperation with corresponding longitudinal grooves in the shaft and is embossed over at least a part of its circumferential surface.

Alternatively or additionally, the cloth may be held to the bobbin by means of serrated clips.

In this way the bobbin is held in its intended position, i e it can not rotate on its shaft if the cloth is exposed to a pulling action due to friction during the cleaning operation, and the cloth in turn is held to the bobbin when exposed to said pulling action.

### THE DRAWING

The invention will be described in further detail below under reference to the accompanying drawing, in which

FIG. 1 is a perspective view of a washing unit for a cylinder in a printing press,

FIG. 2 is a side view of a bobbin for use in the washing unit, and

FIG. 3 is an end view of the bobbin of FIG. 2 with a shaft therefore shown in section.

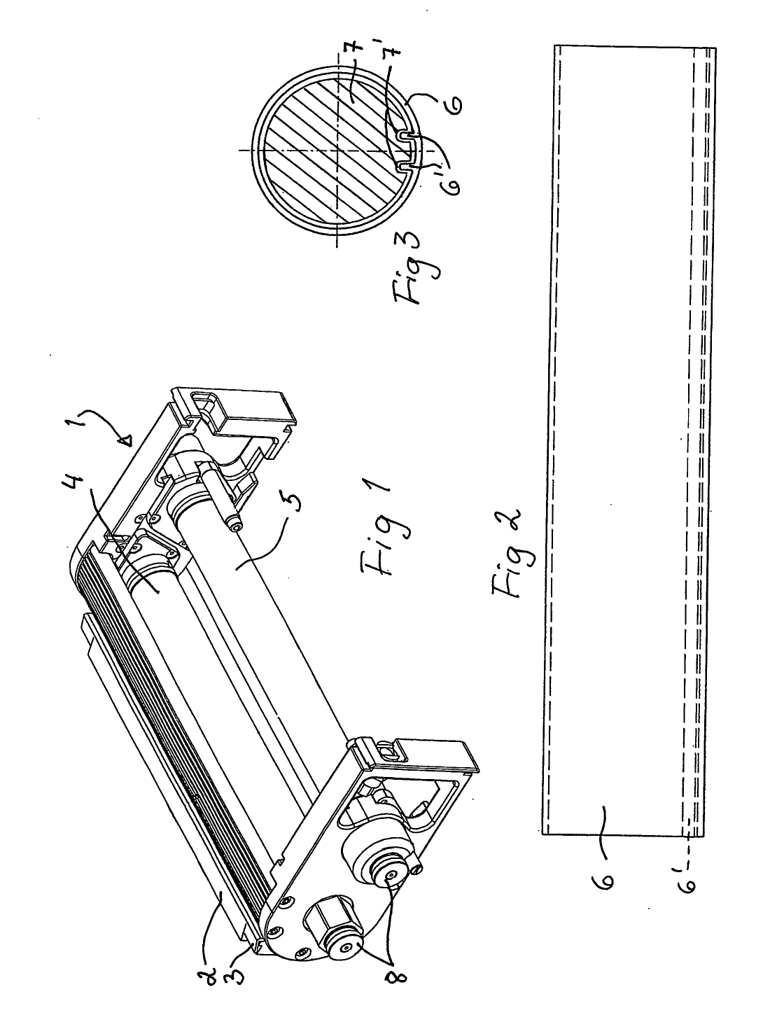

### DETAILED DESCRIPTION OF A PREFERRED EMBODIMENT

As is well known in the printing art, a washing unit 1 may be arranged in the vicinity of a cylinder, for example a blanket cylinder, in a printing press for the purpose of cleaning the cylinder by means of a cloth in the washing unit. When the cylinder is to be cleaned, the washing unit 1 is applied with its cloth against the circumferential cylinder surface; in this stage washing liquid is preferably supplied to the cloth.

The washing unit 1 is known per se and is accordingly only briefly described and to the extent necessary for a proper understanding of the invention.

A cleaning cloth 2 is arranged over a pad 3 at a front end of the washing unit 1 to be brought into engagement with the cylinder to be cleaned. The cloth 2 may be stepwise unrolled from a cloth supply roll 4 and again be rolled up after use on a cloth return roll 5.

Each cloth roll 4, 5 comprises a bobbin 6 (FIGS. 2 and 3) on a conditionally rotatable shaft 7 (only shown in FIG. 3) in the washing unit 1. The shafts with their bobbins may be released from the washing unit 1 by locking means 8 for cloth replacement.

A clean cloth portion is stepwise supplied from the supply roll 4 to the pad 3, before the washing unit 1 is applied to the cylinder to be cleaned. The used cloth is transferred to the return roll 5.

When the entire cloth supply is used-up and the cloth 2 has been gathered on the return roll 5, the bobbin 6 with the used cloth is removed on its shaft 7 from the washing unit and discarded. A new bobbin with a clean cloth is supplied as a supply roll 4 in the proper place in the washing unit, and a new empty bobbin, to which the end of the clean cloth is attached, is mounted in the position for the return roll.

The bobbin 6 is essentially a tube, preferably made of plastic material. The tube has an inner diameter corresponding to the outer diameter of the shaft 7 on which it is to be arranged and a length adapted to the width of the cloth 2.

As is visible in FIG. 3, the bobbin 6 is provided with internal, logitudinal or axial projections 6′ for cooperation with corresponding longitudinal grooves 7 in the shaft 7. The purpose of this arrangement is to keep the shaft 7 and bobbin 6 from relative rotatable movements during operation.

Also, the bobbin 6 is preferably embossed over at least a part of its circumferential surface in order to prevent relative movements between the cloth 2 and the bobbin during operation.

1. A bobbin (6) for a cleaning cloth (2) in a washing unit (1) for a cylinder in a printing press, c h a r a c t e r i z e d in that wherein the bobbin (6) is provided with internal means (6′) for rotationally locking it to its shaft (7) in the washing unit (1) and with external means for preventing sliding tangential movements between the bobbin and the cloth (2).

2. A bobbin according to claim 1, wherein the bobbin (6) is provided with internal, longitudinal or axial projections (6′) for cooperation with corresponding longitudinal grooves (7′) in the shaft (7).

3. A bobbin according to claim 1, wherein the bobbin (6) is embossed over at least a part of its circumferential surface.

4. A bobbin according to any of the preceding claims claim 1 wherein the bobbin (6) is made of a plastic material.
